(19) United States
(12) Patent Application Publication
(10) Pub. No.: US 2023/0419206 A1
(43) Pub. Date: Dec. 28, 2023

(54) SYSTEM AND METHOD FOR OBJECTIVELY CONNECTING ATHLETES WITH COMMON PERFORMANCE METRICS AS RECORDED BY GPS DEVICES

(71) Applicant: David Patrick Moynihan, Grantham, NH (US)

(72) Inventor: David Patrick Moynihan, Grantham, NH (US)

(21) Appl. No.: 18/340,365

(22) Filed: Jun. 23, 2023

Related U.S. Application Data
(60) Provisional application No. 63/366,932, filed on Jun. 24, 2022.

(51) Int. Cl. G06Q 10/0631; H04L 67/52; H04W 4/02; H04L 67/50

(52) U.S. Cl. CPC G06Q 10/063112; H04L 67/52; H04W 4/02; H04L 67/535

(57) ABSTRACT

In an approach to matching athletes for participation in an event, a system may include: a Global Positioning System (GPS) device; a display with a user interface (UI); and one or more computer processors. A first activity data for a user is retrieved from the GPS device. Second activity data is obtained from other athletes that have expressed interest in participating in the event. The first activity data is compared against the second activity data from the other athletes to create recommendations, where the recommendations match one or more types of activities the user participates in and the skill level of the user. The recommendations are displayed to the user on the UI.

### CROSS-REFERENCE TO RELATED APPLICATIONS

The present application claims the benefit of the filing date of U.S. Provisional Application Ser. No. 63/366,932, filed Jun. 24, 2022, the entire teachings of which application is hereby incorporated herein by reference.

### TECHNICAL FIELD

The present application relates generally to distributed data processing for online social networks and, more particularly, to a system and method for objectively connecting athletes with common performance metrics as recorded by Global Positioning System (GPS) devices.

### BACKGROUND

Fitness apps can be a convenient way to track progress, whether from daily activity or from physical workouts, such as bicycle riding. These apps work by tracking the details of your repetitions to your overall weekly miles. Tracking your activity can help you maintain your motivation and encourage you to keep working toward your personal fitness and health goals.

A social network refers to a group of individuals who voluntarily interact on the basis of the interest which they profess for an idea, a problem, a product, etc. A social network may be defined as an online communication platform that is used for creating relationships with other people who share an interest, background, or real relationship, or as a chain of individuals and their personal connections. Social networking applications make use of the associations between individuals to further facilitate the creation of new connections with other people. Connections are made possible when a person starts to invite people as contacts. Through social networking, individuals can find contacts that otherwise may be very unlikely for them to meet.

Artificial intelligence (AI) can be defined as the theory and development of computer systems able to perform tasks that normally require human intelligence, such as speech recognition, visual perception, decision-making, and translation between languages. The term AI is often used to describe systems that mimic cognitive functions of the human mind, such as learning and problem solving.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a distributed data processing environment consistent with the present disclosure.

FIG. 2 is a block diagram of one example system for objectively connecting athletes with common performance metrics as recorded by GPS devices consistent with the present disclosure.

FIG. 3 is a flowchart diagram depicting operations for the connection program, for objectively connecting athletes with common performance metrics as recorded by GPS devices, on the distributed data processing environment of FIG. 1, consistent with the present disclosure.

FIG. 4 depicts a block diagram of components of the computing device executing the connection program within the distributed data processing environment of FIG. 1, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Currently many activities such as cycling, running, alpine/Nordic skiing, etc., are recorded with a GPS device. Existing services cater to performance analytics while allowing athletes to connect, however the athletes must have a common acquaintance, take part in an activity together, or search for each other by name in order to connect. Current services offer limited opportunity for a user to compare himself or herself against other athletes to determine if their athletic abilities are similar or they would enjoy participating together. Current services do offer the ability to plan routes, and provide heat maps indicating what roads are popular, however these services do not recommend routes based on an individual's fitness level or preferred surface type (pavement, gravel, trail, etc.).

For example, cycling is an inherently social experience but finding a community you enjoy cycling with can be a difficult task. Reaching out to the local cycling club in your area can be a great first step but knowing which of the club sponsored rides you will be most successful on is not always obvious. Signing up for your first cycling event, be it a race or Gran Fondo, can be an experience wrought with anxiety, the fear of finishing in last place, or not finishing at all can strip confidence from even the most seasoned of cyclists.

All seasoned cyclists have had the devastating experience of joining a club ride, heading out with many other cyclists only to be left behind at the first climb, and finding themselves riding home alone, slowly turning the pedals, head down, trying to understand why the ride advertised as “B group, 16 mph average” was so much more difficult than anticipated. Currently when clubs and sponsored events are advertised, subjective descriptors are used to describe the planned ride such as “spirited,” “race pace”, or “no drop”. While an experienced cyclist may be able to interpret these subjective terms, they will not always accurately interpret the description, and the new cyclist still learning the terminology certainly does not have the foundation to understand if a described ride is suitable for their fitness level.

Every day, millions of athletes are tracking their activities using a GPS device, such as a smart phone, recording information about their activity such as where they were, their pace, elevation gain, power output, grade of hills climbed, rests taken during the activity, etc. There are currently many methods and apps for tracking activities and observing what activities known acquaintances have taken part in, but what is not offered is an objective method for being paired with club rides, events, or individual athletes that compliment an individual's ability and activity preferences. Current platforms offer a way to connect with athletes who the user knows in the community, but the user needs to know the athlete's name to enter it in a search or have previously participated in an activity with the athlete to be able to connect.

There exists a need for an objective method for using activity analytics recorded by a user's GPS device to aid the athlete in finding club rides, events, and individual athletes which complement the user's current athletic ability not currently offered by the platforms prevalent within the athletic world. By taking an objective approach using data to select the appropriate people, clubs, and events to ride with or take part in, the athlete is better equipped to enjoy their experience.

Disclosed herein is a system and computer-implemented method for objectively connecting athletes with common performance metrics as recorded by GPS devices, as well as for matching athletes for participation in an event in which they share a common interest and similar skill level. In one example for a cyclist, when a club advertises a weekly group ride with multiple skill level groupings, rather than the athlete needing to read the subjective descriptors of the “A group”, “B Group”, and “C Group”, the athlete uses the disclosed system to compare their recent activities with the planned club ride and historical data of past club rides. In this example, the method would determine that the athlete is most closely matched with the “B Group” based on their current fitness level. By taking an objective approach using data to select the appropriate group to ride with, the athlete is better equipped to enjoy their first experience with the club.

The disclosed system works by receiving data, such as cycling, running, alpine/Nordic skiing, etc., recorded with a GPS device. Many current services generally provide an Application Programming Interface (API) allowing third party applications to use the activity data. This data can be uploaded directly by the disclosed system or imported from other applications, such as those services that are currently widely used to track activities. User generated GPS-based activity data contains information including the athlete's performance metrics, route, time of day, start/end location, road/surface types. Athletes who take part in a variety of races, events, club activities, shop rides, etc., can develop an “activity resume” allowing other users the ability to quickly see how an athlete engages in the athletic community.

Although some of the examples that follow are presented from the perspective of a cyclist, similar metrics from a variety of sports including, but not limited to, running, Nordic skiing, downhill skiing, hiking, backcountry skiing, etc., can be used in the same fashion to match athletes with others of similar ability. Also, a system and method consistent with the present disclosure is not limited to use of the metrics described herein. Indeed, a wide variety of metrics including commonly calculated metrics and custom metrics, may be used in a system and method consistent with the present disclosure.

Once an athlete has uploaded their activity data, the system compares the data against that of other athletes. In many cases, these other athletes are unknown users, and their data is otherwise inaccessible to the user. Social connection recommendations are made based on a variety of metrics allowing athletes to find other athletes with whom they may enjoy participating. These metrics may include, but are not limited to, geographical location, average speed, average elevation gain per ride, preferred routes/surface type, preferred starting point, workout frequency, workout intensity, typical competitions, or events the user takes part in. Note that although this example lists metrics most applicable to cycling, the system works with many other activities and the metrics that may be chosen for any particular activity are metrics that may be appropriate for that activity.

In one example comparison metric for activity based social recommendations, two cyclists can be compared using their average watts per kilogram produced. For example, if a 68 kg cyclist can produce an average of 272 watts, they will be able to complete a given course in the same time as an 80 kg cyclist who can average 320 watts. Both cyclists have an average of four watts per kilogram. By further analyzing the data contained within an athlete's GPS activity file, the variance from the average power produced can be determined, e.g., two cyclists who each average four watts per kilogram may not be a good match. Cyclist #1 may be able to produce much higher power while climbing than on an ascent or flat portion of a course. Conversely, cyclist #2 may be able to hold their average power output much more consistently. Although these two cyclists produce the same average power, were they to be matched and ride together, one would find that cyclist #1 would be waiting at the top of climbs for cyclist #2, and once they regroup, cyclist #2 would leave cyclist #1 behind on the descent. Therefore, based on the data from each athlete's GPS activity file, the system may determine that cyclist #1 and cyclist #2 are not a good fit.

In another example for a cycling activity, the system makes activity-based route recommendations and distance recommendations. While existing services allow for route planning and provide “heat maps” identifying where other people like to cycle/run/ski most frequently, these services do not apply user preferences to heat maps. Route and distance recommendations based on a user's activity history can be made based on a variety of metrics allowing users to find new routes they may enjoy. For example, these metrics may include, but are not limited to, a preferred starting point, a geographic location, a route length, a surface type (e.g., pavement, single track, gravel, etc.), an elevation gain per mile, routes representative of events the user is registered for, routes suitable for equipment the user currently has, i.e., gravel bike, mountain bike, etc., user's desire for new challenges such as increased distance, elevation gain, new surfaces, etc.

Similar to the route recommendation feature, race/event recommendations considers a variety of metrics contained within the athlete's activity data. This feature also allows for monetization, where races/events can self-promote within the application, seeking out athletes who have taken part in similar events. Users may be alerted to races/events their social connections are registered to take part in. Race/event recommendations based on a user's activity history are made based on a variety of metrics allowing users to find new routes they may enjoy. In some embodiments, these recommendations may be based on, but not limited to, past races/events, geographic location, race/event length, surface type (e.g., pavement, single track, gravel, etc.), elevation gain per mile, races/events similar to others the user is registered for, races/events suitable for equipment user currently has, the user's desire for new challenges such as increased distance, elevation gain, new surfaces, etc.

Athletes, and particularly new athletes, often find it difficult to know if an activity advertised by a local club or shop is suitable for their fitness level. In the disclosed system, a user's activity history is used, for example, to identify group rides promoted by local bicycle shops or activities promoted by clubs for various activities such as running, cycling, skiing, hiking, etc., in which the user may be interested. Comparing the athlete's historical performance with that of regular participants in those activities will prevent an athlete from joining an activity that is more difficult than the athlete may be capable of taking part in, thereby increasing the probability the athlete is successful. Athletes who are new to a geographical region or are in the area for a short period of time can quickly find structured activities to join while being confident that they will be successful. Group activity recommendations are made based on similar metrics found within a user's uploaded data used for activity, route, and other event recommendations. Group leaders can invite athletes directly and share routes through the platform.

By providing the ability for access to user data (with the user's consent), equipment retailers can use an athlete's GPS activity data to understand their preferences and recommend suitable equipment for that athlete. For example, a cyclist looking to purchase a bicycle that can accommodate the variety of paved and gravel roads he or she is accustomed to arrives at a local bicycle retailer. The bicycle shop employee reviews the athlete's activity profile and is able to identify that gravel roads make up 85% of this cyclist's routes and have an average elevation gain of 90 feet per mile, and the bicycle shop employee also sees that the athlete often rides in adverse conditions such as heavy rain. Understanding these conditions allows the bicycle shop employee to recommend a lighter bicycle with larger tire clearance and an aggressive tire tread more suitable for significant climbing on wet or muddy dirt/gravel roads.

The system disclosed herein also allows for monetization through activity-based advertising. Amateur athletes as a demographic are consistently researching their equipment purchases in an effort to identify what equipment will provide an edge at the next event. A user's activity history (with the user's consent) may be used to generate equipment recommendations from manufacturers based on the type of activities a user takes part in. Rather than exposing users to a barrage of advertisements on the platform, if an individual typically rides a mountain bike at terrain parks, advertisements focus on equipment for that application. Likewise, if an individual focuses on backcountry skiing, they would not see recommendations for cycling equipment. Retailers and manufacturers may offer a “decision guide” where users can research suitable equipment based on their activity history. This approach is focused on users seeking equipment to purchase rather than providing users with unsolicited advertisements. The disclosed system would provide companies with valuable data on market conditions, activities increasing in popularity, activities in decline, regional activity preferences, etc.

For example, a manufacturer with an aerodynamic bicycle frame that saves 10 watts over comparable bicycles can provide a user with data showing that the race they took part in recently and finished in 3 hours and 14 minutes would have been completed in 3 hours and 6 minutes by using this more aerodynamic frameset. This time improvement would have improved the user's finishing position from 87th place of 300 riders to 46th place.

By presenting objective data to users demonstrating the benefits of their products, manufacturers can market products based on that product's merits, rather than relying on the subjective opinions of bike shop owners and the general cycling community. Additionally, there is the opportunity for manufacturers to gain insights into trends in real time, understanding what types of activities are increasing and decreasing in popularity within different demographics and in different areas of the world.

Machine learning (ML) is an application of AI that creates systems that have the ability to automatically learn and improve from experience. ML involves the development of computer programs that can access data and learn based on that data. ML algorithms typically build mathematical models based on sample, or training, data in order to make predictions or decisions without being explicitly programmed to do so. The use of training data in ML requires human intervention for feature extraction in creating the training data set. The two main types of ML are Supervised learning and Unsupervised learning. Supervised learning uses labeled datasets that are designed to train or “supervise” algorithms into classifying data or predicting outcomes accurately. Supervised learning is typically used for problems requiring classification or regression analysis. Classification problems use an algorithm to accurately assign test data into specific categories. Regression is a method that uses an algorithm to understand the relationship between dependent and independent variables. Regression models are helpful for predicting numerical values based on different data points.

Deep learning is a sub-field of ML that automates much of the feature extraction, eliminating some of the manual human intervention required and enabling the use of larger data sets. Deep learning typically uses neural networks, which are highly interconnected entities, called nodes. Each node, or artificial neuron, connects to another and has an associated weight and threshold. A node multiplies the input data with the weight, which either amplifies or dampens that input, thereby assigning significance to inputs with regard to the task the algorithm is trying to learn. If the output of any individual node is above the specified threshold value, that node is activated, sending data to the next layer of the network. Otherwise, no data is passed along to the next layer of the network. A neural network that consists of more than three layers can be considered a deep learning algorithm or a deep neural network.

The disclosed system may use AI and/or ML for objectively connecting athletes with common performance metrics as recorded by GPS devices, as well as for matching athletes for participation in an event in which they share a common interest and similar skill level. Some tasks that the disclosed system may use AI and/or ML for may include, but are not limited to, performing data analysis, and determining athlete connections, exercise, and route operations, etc.

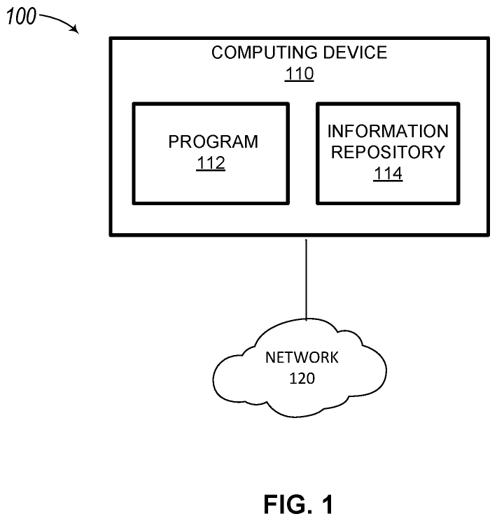

FIG. 1 is a functional block diagram illustrating a distributed data processing environment, generally designated 100, suitable for operation of the program 112, consistent with the present disclosure. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

Distributed data processing environment 100 includes computing device 110 optionally connected to network 120. Network 120 can be, for example, a telecommunications network, a local area network (LAN), a wide area network (WAN), such as the Internet, or a combination of the three, and can include wired, wireless, or fiber optic connections. Network 120 can include one or more wired and/or wireless networks that are capable of receiving and transmitting data, voice, and/or video signals, including multimedia signals that include voice, data, and video information. In general, network 120 can be any combination of connections and protocols that will support communications between computing device 110 and other computing devices (not shown) within distributed data processing environment 100.

Computing device 110 can be a standalone computing device, a mobile computing device, or any other electronic device or computing system capable of receiving, sending, and processing data. In some embodiments, computing device 110 may be a smart phone that includes the GPS device and may also include a display and a User Interface (UI) that may be used by the system or computer-implemented method disclosed herein.

In other embodiments, computing device 110 can be a personal computer (PC), a desktop computer, a laptop computer, a tablet computer, a netbook computer, or any programmable electronic device capable of communicating with other computing devices (not shown) within distributed data processing environment 100 via network 120. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers) that act as a single pool of seamless resources when accessed within distributed data processing environment 100.

In an embodiment, computing device 110 includes the program 112. In an embodiment, the program 112 is a program, application, or subprogram of a larger program for objectively connecting athletes with common performance metrics as recorded by GPS devices. In an alternative embodiment, the program 112 may be located on any other device accessible by computing device 110 via network 120.

In an embodiment, computing device 110 includes information repository 114. In an embodiment, information repository 114 may be managed by the program 112. In an alternate embodiment, information repository 114 may be managed by the operating system of the computing device 110, alone, or together with, the program 112. Information repository 114 is a data repository that can store, gather, compare, and/or combine information. In some embodiments, information repository 114 is located externally to computing device 110 and accessed through a communication network, such as network 120. In some embodiments, information repository 114 is stored on computing device 110. In some embodiments, information repository 114 may reside on another computing device (not shown), provided that information repository 114 is accessible by computing device 110. Information repository 114 includes, but is not limited to, system data, activity data, event data, group data, route data, equipment data, connection data, recommendation data, advertising data, and other data that is received by the program 112 from one or more sources, and data that is created by the program 112.

Information repository 114 may be implemented using any non-transitory volatile or non-volatile storage media for storing information, as known in the art. For example, information repository 114 may be implemented with random-access memory (RAM), solid-state drives (SSD), one or more independent hard disk drives, multiple hard disk drives in a redundant array of independent disks (RAID), optical library, or a tape library. Similarly, information repository 114 may be implemented with any suitable storage architecture known in the art, such as a relational database, an object-oriented database, or one or more tables.

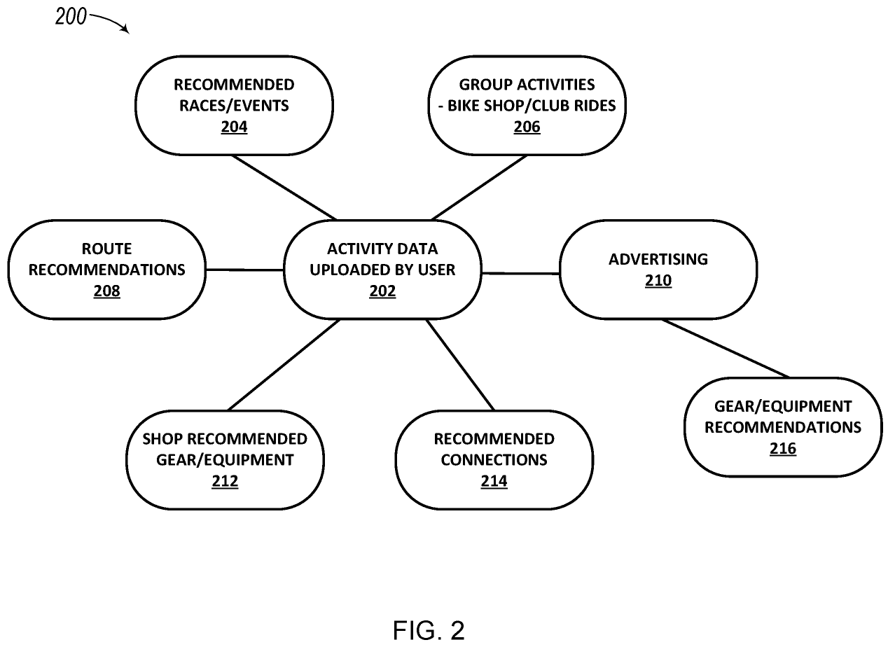

FIG. 2 is a block diagram of one example system, generally designated 200, for objectively connecting athletes with common performance metrics as recorded by GPS devices, e.g., a smart phone, a smart watch, or an activity-based GPS device that uploads the activity data to a device such as an app on a smart phone. In the example of FIG. 2, activity data is uploaded by the user in block 202. In some instances, the activity data may be automatically uploaded to the system. The system collects the activity data and analyzes the data to make recommendations to the user for activities that match both the types of activities that the user participates in, as well as one or more skill level recommendations based on the skill level of the user. In this example, the types of recommendations made by the disclosed system include recommended races or other events in block 204, group activities, e.g., bike shop or club rides, in block 206, recommended routes in block 208, and recommended connections, i.e., social connections, in block 214. In addition, the system may also provide recommendations for gear and equipment recommended by a shop based on the user's activity analytics in block 212. The system may also, with the consent of the user, allow advertising that is specifically tailored to the user based on the activity analytics in block 210, as well as gear and equipment recommendations that are specifically tailored to the user based on the activity analytics in block 216.

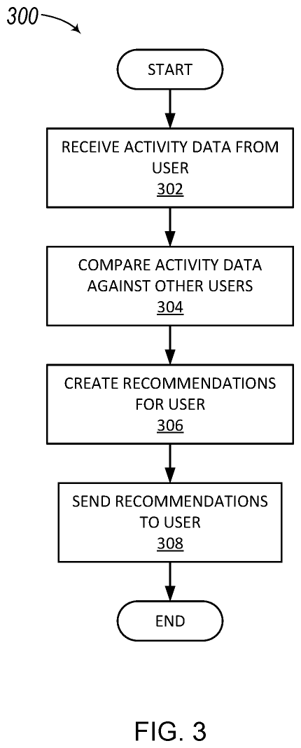

FIG. 3 is a flowchart diagram, generally designated workflow 300, depicting operations for the program 112, for objectively connecting athletes with common performance metrics as recorded by GPS devices, on the distributed data processing environment of FIG. 1, consistent with the present disclosure. In an alternative embodiment, the operations of workflow 300 may be performed by any other program while working with the program 112.

It should be appreciated that embodiments of the present disclosure provide at least for objectively connecting athletes with common performance metrics as recorded by GPS devices. However, FIG. 3 provides only an illustration of one implementation and does not imply any limitations with regard to the environments in which different embodiments may be implemented. Many modifications to the depicted environment may be made by those skilled in the art without departing from the scope of the disclosure as recited by the claims.

It should be appreciated that the example flowchart diagram of FIG. 3 shows a single cycle of the operation of the program 112, which repeats each time the user requests a recommendation.

The program 112 receives activity data from the user (operation 302). In the illustrated example embodiment, the program 112 receives data, such as cycling, running, alpine/Nordic skiing, recorded with a user's GPS device, e.g., a smart phone. In some embodiments, this data can be uploaded directly by the disclosed system or imported from other applications, such as those services that are currently widely used to track activities. In some embodiments, since many current services generally provide an API allowing third party applications to use the activity data, the program 112 automatically retrieves the activity data from the user's GPS device, after receiving the user's consent.

User generated GPS-based activity data contains information including, but not limited to, the athlete's performance metrics, route, time of day, start/end location, road/surface types. Athletes who take part in a variety of races, events, club activities, shop rides, etc., can develop an “activity resume” allowing other athletes the ability to quickly see how an athlete engages in the athletic community.

The program 112 compares the activity data against other athletes (operation 304). Once an athlete has uploaded their activity data, the program 112 compares the data against that of other athletes. In some embodiments, the program 112 contains a database of users, including a variety of metrics that may be used to make recommendations to users. In other embodiments, the program 112 actively retrieves the metrics from participating users, i.e., those users who have consented to having their activity data retrieved and used for making recommendations, to compare to the metrics for the current user. In some embodiments, the program 112 obtains the activity data from one or more athletes that have expressed interest in participating in an event in which the user has expressed interest in participating. For example, the athletes may have expressed interest in participating in an event by signing up for an event using an application provided by an event organizer. In some embodiments, athletes and/or their associated metrics may not be known to the user, but a system consistent with the present disclosure may still compare the activity data and make recommendations to the user.

In some embodiments, these metrics may include, but are not limited to, geographical location, average speed, average elevation gain per ride, preferred routes/surface type, preferred starting point, workout frequency, workout intensity, typical competitions or events user takes part in. For example, the program 112 may match metrics such as the average speed on a given grade hill for two athletes rather than for a specific road, path, or segment. This may result in a more accurate match between the two athletes since it is based on specific metrics.

The program 112 creates recommendations for the user (operation 306). The program 112 creates recommendations based on a desired activity of the user and a variety of desired metrics, such as those listed in operation 304 above, allowing athletes to find other athletes they may enjoy participating with. Based on the metrics selected by the user, and the type of recommendation the user has requested, the program 112 may make activity based social recommendations, e.g., recommending one or more users that participate in the same activity and have similar metrics to the user. The program 112 may make a subgroup recommendation to participate in an event with a subgroup of unknown users, e.g., using one or more preselected metrics and/or based on the metrics selected by the user.

If the user has selected an activity-based route recommendation, then the program 112 makes recommendations based on the user's activity history based on a variety of metrics allowing users to find new routes they may enjoy. For example, these metrics may include, but are not limited to, a preferred starting point, a geographic location, a route length, a surface type (e.g., pavement, single track, gravel, etc.), an elevation gain per mile, routes representative of events the user is registered for, routes suitable for equipment the user currently has, e.g., gravel bike, mountain bike, etc., user's desire for new challenges such as increased distance, elevation gain, new surfaces, etc. If the user has selected a race/event recommendations, then the program 112 makes recommendations based on a variety of metrics contained within the athlete's activity data.

If the user has selected a distance event, then the program 112 may estimate the time to complete a distance associated with the distance event by the user and estimating an athlete time to complete the distance associated with the distance event by each of one or more athletes that the program 112 has determined may have an interest in the distance event. The program 112 obtains route information regarding the route associated with the distance event and estimates the time to complete the distance associated with the distance event by the user and the athlete time to complete the distance associated with the event in response to the route information. If the user has selected a distance event recommendation, then the program 112 makes recommendations of one or more athletes based on the estimated time to complete the distance associated with the distance event by the user and the one or more athletes.

Athletes, and particularly new athletes, often find it difficult to know if an activity advertised by a local club or shop is suitable for their fitness level. If the user has selected an activity advertised by a local club or shop, then the program 112 compares the user's activity history to activities promoted by clubs or local shops for various activities such as running, cycling, skiing, hiking, etc., which the user may be interested in. The program 112 compares the athlete's historical performance with that of regular participants in those activities to prevent an athlete from joining an activity that is more difficult than the athlete may be capable of taking part in, thereby increasing the probability the athlete is successful.

Similarly, athletes who are new to a geographical region or are in the area for a short period of time can quickly find structured activities to join while being confident that they will be successful. The program 112 makes group activity recommendations based on similar metrics found within a user's uploaded data used for activity, route, and other event recommendations. A user's activity history is used by the program 112 to identify, for example, group rides promoted by local bicycle shops or activities promoted by clubs for various activities such as running, cycling, skiing, hiking, etc., which the user may be interested in. By comparing the user's historical performance with that of regular participants in those activities, the program 112 may prevent an athlete from joining an activity that is more difficult than the athlete may be capable of taking part in, thereby increasing the probability the athlete is successful.

The program 112 sends recommendations to the user (operation 308). The program 112 sends recommendations to the user based on the type of recommendation the user has requested, which may include, but are not limited to, activity based social recommendations, race/event recommendations, advertised event recommendations, group activity recommendations, equipment recommendations, etc. In some embodiments, the program 112 may send the recommendations to the user's smart phone, which may display the recommendation via a UI. In some embodiments, the program 112 may send the recommendations as a list. In some other embodiments, the program 112 may send the recommendations as a database. In yet some other embodiments, the program 112 may display a map of the geographic area selected by the user and display recommendations on the map. In yet other embodiments, the program 112 may send the recommendations to the user using any appropriate method as would be known to a person of skill in the art.

In some embodiments, the program 112 may, with the user's consent, allow equipment retailers to use an athlete's GPS activity data to understand the user's preferences and recommend suitable equipment for that user. For example, a cyclist looking to purchase a bicycle that can accommodate the variety or paved and gravel roads the cyclist is accustomed to arrives at a local bicycle retailer. The program 112 displays the user's activity profile so the bicycle shop employee can review it and identifies that gravel roads make up 85% of this cyclist's routes and have an average elevation gain of 90 feet per mile. From this display, the bicycle shop employee also sees that the athlete often rides in adverse conditions such as heavy rain. Understanding these conditions allows the bicycle shop employee to recommend a lighter bicycle with larger tire clearance and an aggressive tire tread more suitable for significant climbing on wet or muddy dirt/gravel roads. The program 112 then ends for this cycle.

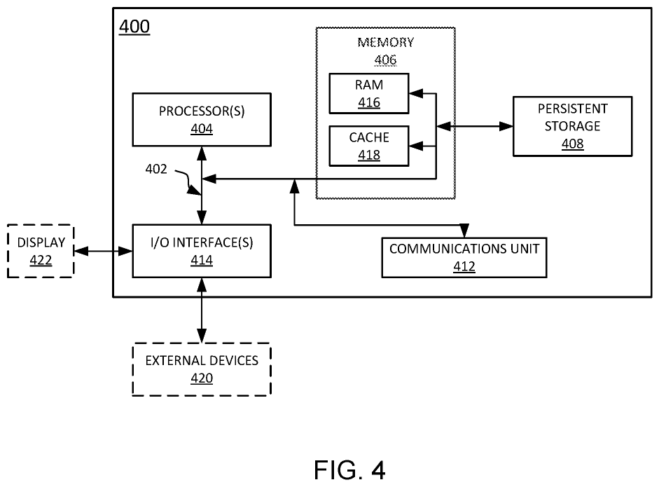

FIG. 4 is a block diagram depicting components of one example 400 of the computing device 110 suitable for the program 112, within the distributed data processing environment of FIG. 1, consistent with the present disclosure. FIG. 4 displays the computing device or computer 400, one or more processor(s) 404 (including one or more computer processors), a communications fabric 402, a memory 406 including, a random-access memory (RAM) 416 and a cache 418, a persistent storage 408, a communications unit 412, I/O interfaces 414, a display 422, and external devices 420. It should be appreciated that FIG. 4 provides only an illustration of one embodiment and does not imply any limitations with regard to the environments in which different embodiments may be implemented. Many modifications to the depicted environment may be made.

As depicted, the computer 400 operates over the communications fabric 402, which provides communications between the computer processor(s) 404, memory 406, persistent storage 408, communications unit 412, and input/output (I/O) interface(s) 414. The communications fabric 402 may be implemented with an architecture suitable for passing data or control information between the processors 404 (e.g., microprocessors, communications processors, and network processors), the memory 406, the external devices 420, and any other hardware components within a system. For example, the communications fabric 402 may be implemented with one or more buses.

The memory 406 and persistent storage 408 are computer readable storage media. In the depicted embodiment, the memory 406 comprises a RAM 416 and a cache 418. In general, the memory 406 can include any suitable volatile or non-volatile computer readable storage media. Cache 418 is a fast memory that enhances the performance of processor(s) 404 by holding recently accessed data, and near recently accessed data, from RAM 416.

Program instructions for the program 112 may be stored in the persistent storage 408, or more generally, any computer readable storage media, for execution by one or more of the respective computer processors 404 via one or more memories of the memory 406. The persistent storage 408 may be a magnetic hard disk drive, a solid-state disk drive, a semiconductor storage device, flash memory, read only memory (ROM), electronically erasable programmable read-only memory (EEPROM), or any other computer readable storage media that is capable of storing program instruction or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

The communications unit 412, in these examples, provides for communications with other data processing systems or devices. In these examples, the communications unit 412 includes one or more network interface cards. The communications unit 412 may provide communications through the use of either or both physical and wireless communications links. In the context of some embodiments of the present disclosure, the source of the various input data may be physically remote to the computer 400 such that the input data may be received, and the output similarly transmitted via the communications unit 412.

The I/O interface(s) 414 allows for input and output of data with other devices that may be connected to computer 400. For example, the I/O interface(s) 414 may provide a connection to external device(s) 420 such as a keyboard, a keypad, a touch screen, a microphone, a digital camera, and/or some other suitable input device. External device(s) 420 can also include portable computer readable storage media such as, for example, thumb drives, portable optical or magnetic disks, and memory cards. Software and data used to practice embodiments of the present disclosure, e.g., the program 112, can be stored on such portable computer readable storage media and can be loaded onto persistent storage 408 via the I/O interface(s) 414. I/O interface(s) 414 also connect to a display 422.

Display 422 provides a mechanism to display data to a user and may be, for example, a computer monitor. Display 422 can also function as a touchscreen, such as a display of a tablet computer.

According to one aspect of the disclosure, there is thus provided a system for matching athletes for participation in an event, the system including: a Global Positioning System (GPS) device; a display with a UI; one or more computer processors, the one or more computer processors configured to: retrieve a first activity data for a user from the GPS device; obtain one or more second activity data from one or more other athletes that have expressed interest in participating in the event; compare the first activity data against the one or more second activity data from the one or more other athletes to create one or more recommendations, where the one or more recommendations match one or more types of activities the user participates in and a skill level of the user; and display the one or more recommendations to the user on the UI.

According to another aspect of the disclosure, there is thus provided a method for matching athletes for participation in an event, the computer-implemented method comprising: retrieving, by one or more computer processors, a first activity data for a user from a Global Positioning System (GPS) device; obtaining, by the one or more computer processors, one or more second activity data from one or more other athletes that have expressed interest in participating in the event; comparing, by the one or more computer processors, the first activity data against the one or more second activity data from the one or more other athletes to create one or more recommendations, where the one or more recommendations match one or more types of activities the user participates in and a skill level of the user; and sending, by the one or more computer processors, the one or more recommendations to the user.

According to yet another aspect of the disclosure, there is thus provided a system for matching athletes for participation in an event, the system comprising one or more computer processors, the one or more computer processors configured to: retrieve a first activity data for a user; obtain one or more second activity data from one or more other athletes that have expressed interest in participating in the event; compare the first activity data against the one or more second activity data from the one or more other athletes to create one or more recommendations, where the one or more recommendations match one or more types of activities the user participates in and a skill level of the user; and send the one or more recommendations to the user.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system and/or a computer-implemented method. The system may include a non-transitory computer readable storage medium (or media) having computer readable program instructions thereon for causing a processor to carry out aspects of the present disclosure.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an EPROM or Flash memory, a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for matching athletes for participation in an event, the system comprising:
a Global Positioning System (GPS) device;
a display with a user interface (UI);
one or more computer processors, the one or more computer processors configured to:
retrieve a first activity data for a user from the GPS device;
obtain one or more second activity data from one or more other athletes that have expressed interest in participating in the event;
compare the first activity data against the one or more second activity data from the one or more other athletes to create one or more recommendations, wherein the one or more recommendations match one or more types of activities the user participates in and a skill level of the user; and
display the one or more recommendations to the user on the UI.

2. The system of claim 1, wherein retrieve the first activity data for the user from the GPS device further comprises accessing the first activity data using an Application Programming Interface (API) to retrieve the first activity data from the GPS device.

3. The system of claim 1, wherein compare the first activity data against the one or more second activity data from the one or more other athletes to create the one or more recommendations further comprises:
determine one or more first performance metrics from the user;
determine one or more second performance metrics from the one or more second activity data for each of the one or more other athletes; and
compare the one or more first performance metrics against the one or more second performance metrics for each of the one or more other athletes.

4. The system of claim 3, wherein compare the first activity data against the one or more second activity data from the one or more other athletes to create the one or more recommendations, wherein the one or more recommendations match the one or more types of activities the user participates in and the skill level of the user further comprises:
receive a desired activity and one or more desired metrics for the user;
compare the one or more desired metrics to the one or more second performance metrics for each other of the one or more other athletes based on the desired activity; and
create the one or more recommendations for the user based on comparing the one or more desired metrics to the one or more second performance metrics for each other of the one or more other athletes.

5. The system of claim 4, wherein the one or more desired metrics and the one or more second performance metrics include at least one of a preferred starting point, a geographic location, a route length, a surface type, an elevation gain per mile, one or more routes representative of events the user is registered for, one or more routes suitable for equipment the user currently has, and a desire for one or more new challenges by the user.

6. The system of claim 5, wherein:
the surface type includes at least one of pavement, a single track, and gravel; and
the one or more new challenges includes at least one of increased distance, the elevation gain, and one or more new surfaces.

7. The system of claim 1, wherein:
the event has a plurality of skill level groupings in which the one or more other athletes may participate; and
the one or more recommendations includes one or more skill level recommendations to participate in one of the skill level groupings.

8. The system of claim 1, wherein the event is a distance event, and comparing the first activity data against the one or more second activity data comprises:
determine a first time to complete a distance associated with the distance event by the user; and
determine an athlete time to complete the distance associated with the distance event for each of the one or more other athletes.

9. The system of claim 8, further comprising:
obtain route information regarding a route associated with the distance event; and
determine the first time and the athlete time based on the route information.

10. The system of claim 1, wherein the one or more other athletes include a plurality of unknown users, wherein the one or more second activity data from the one or more other athletes is otherwise inaccessible to the user.

11. The system of claim 10, wherein the one or more recommendations for the user comprises a subgroup recommendation to participate in the event with a subgroup of the plurality of unknown users.

12. The system of claim 1, wherein:
the one or more recommendations are sent to the user as at least one of a list, a database, and a map of a geographic area selected by the user; and
the recommendations are displayed on the map by the UI.

13. A computer-implemented method for matching athletes for participation in an event, the computer-implemented method comprising:
retrieving, by one or more computer processors, a first activity data for a user from a Global Positioning System (GPS) device;
obtaining, by the one or more computer processors, one or more second activity data from one or more other athletes that have expressed interest in participating in the event;
comparing, by the one or more computer processors, the first activity data against the one or more second activity data from the one or more other athletes to create one or more recommendations, wherein the one or more recommendations match one or more types of activities the user participates in and a skill level of the user; and
sending, by the one or more computer processors, the one or more recommendations to the user.

14. The computer-implemented method of claim 13, wherein compare the first activity data against the one or more second activity data from the one or more other athletes to create the one or more recommendations further comprises:
determining, by the one or more computer processors, one or more first performance metrics from the user;
determining, by the one or more computer processors, one or more second performance metrics from the one or more second activity data for each of the one or more other athletes; and
comparing, by the one or more computer processors, the one or more first performance metrics against the one or more second performance metrics for each of the one or more other athletes.

15. The computer-implemented method of claim 14, wherein compare the first activity data against the one or more second activity data from the one or more other athletes to create the one or more recommendations, wherein the one or more recommendations match the one or more types of activities the user participates in and the skill level of the user further comprises:
receiving, by the one or more computer processors, a desired activity and one or more desired metrics for the user;
comparing, by the one or more computer processors, the one or more desired metrics to the one or more second performance metrics for each other of the one or more other athletes based on the desired activity; and
creating, by the one or more computer processors, the one or more recommendations for the user based on comparing the one or more desired metrics to the one or more second performance metrics for each other of the one or more other athletes.

16. The computer-implemented method of claim 13, wherein the event has a plurality of skill level groupings in which the one or more other athletes may participate, and wherein the one or more recommendations includes one or more skill level recommendations to participate in one of the skill level groupings.

17. The computer-implemented method of claim 16, wherein the event is a distance event, and comparing the first activity data against the one or more second activity data comprises:
determining, by the one or more computer processors, a first time to complete a distance associated with the distance event by the user; and
determining, by the one or more computer processors, an athlete time to complete the distance associated with the distance event for each of the one or more other athletes.

18. The computer-implemented method of claim 17, further comprising:
obtaining, by the one or more computer processors, route information regarding a route associated with the distance event; and
determining, by the one or more computer processors, the first time and the athlete time based on the route information.

19. The computer-implemented method of claim 18, wherein:
the one or more other athletes include a plurality of unknown users, wherein the one or more second activity data from the one or more other athletes is otherwise inaccessible to the user; and
the one or more recommendations for the user comprises a subgroup recommendation to participate in the event with a subgroup of the plurality of unknown users.

20. A system for matching athletes for participation in an event, the system comprising one or more computer processors, the one or more computer processors configured to:
retrieve a first activity data for a user;
obtain one or more second activity data from one or more other athletes that have expressed interest in participating in the event;
compare the first activity data against the one or more second activity data from the one or more other athletes to create one or more recommendations, wherein the one or more recommendations match one or more types of activities the user participates in and a skill level of the user; and
send the one or more recommendations to the user.
